(19) United States
(12) Patent Application Publication
(10) Pub. No.: US 2011/0019957 A1
(43) Pub. Date: Jan. 27, 2011

(54) MAGNETO-OPTO MICRO-RING RESONATOR AND SWITCH

(75) Inventor: Kamal Alameh, Western Australia (AU)

Correspondence Address: HOWARD & HOWARD ATTORNEYS PLLC, 450 West Fourth Street, Royal Oak, MI, 48067, US

(73) Assignee: ST SYNERGY LIMITED, Balcatta (AU)

(21) Appl. No.: 12/517,927

(22) PCT Filed: Dec. 4, 2007
(86) PCT No.: PCT/AU2007/001871

§ 371 Date: Oct. 8, 2010

Related U.S. Application Data
(60) Provisional application No. 60/868,792, filed on Dec. 6, 2006.

(51) Int. Cl. G02F 1/095; G02F 1/09

(52) U.S. Cl. 385/6

(57) ABSTRACT

An apparatus, method, system, and computer-program product for magneto-optic (MO) switching produces magneto-optic materials in blue and green light wavelengths. An MO switching apparatus includes a first waveguide supporting a propagation of a radiation signal from a first port to a second port; a second waveguide including a second port; and a ring-oscillator having a closed propagation pathway including magneto-optic materials, said ring-oscillator operationally coupled to said waveguides and responsive to a controlling influence to switch between a first mode and a second mode, with said first mode substantially non-interfering with said propagation of said radiation signal in said first waveguide and with said second mode routing said propagation of said radiation signal from said first port to said second port.

### FIELD OF THE INVENTION

The present invention relates generally to micro-ring oscillators, and more particularly to micro-ring oscillators using a magnetic switching paradigm that includes multilayer optical materials and multilayer magneto-optic photonic crystal materials tuned to produce an enhanced Faraday Rotation and transmission at particular wavelengths of radiation.

### BACKGROUND

Faraday rotation, also called the Faraday Effect, is well-known in general, and its application to telecommunications systems using signals in the infrared spectrum is extensive. In brief, the Faraday Effect provides for changing a polarization angle of a radiation signal when a magnetic field is present in the direction of propagation. An amount of polarization angle change is a function of magnetic field strength, distance over which the magnetic field acts, and a Verdet constant of the material through which the radiation signal is propagating.

An advantage of some telecommunications systems is that they operate using infrared frequencies. At infrared frequencies, materials exist having good Verdet constants and good transmissivity constants. Material properties and structures affecting the Faraday Effect have been extensively explored for these applications.

Current micro-ring oscillators generally rely on electric fields for switching/coupling between waveguides/ports and are referred to as electro-optic micro-ring resonators. Micro-ring oscillators typically require special input polarization control, among other requirements.

An add-drop multiplexer (ADM) is an important element of optical fiber networks. A multiplexer combines, or multiplexes, several lower-bandwidth streams of data into a single beam of light. An add-drop multiplexer is a multiplexer that has the capability to add one or more lower-bandwidth signals to an existing high-bandwidth data stream, and at the same time can extract or drop other low-bandwidth signals, removing them from the stream and redirecting them to some other network path. This is used as a local “on-ramp” and “off-ramp” to the high-speed network.

ADMs are used both in long-haul core networks and in shorter-distance “metro” networks, although the former are much more expensive due to the difficulty of scaling the technology to the high data rates and dense wavelength division multiplexing (DWDM) used for long-haul communications. A main optical filtering technology used in add-drop multiplexers is the Fabry-Pérot etalon.

A recent shift in ADM technology has introduced so called “multi-service SONET/SDH” (also known as a multi-service provisioning platform or MSPP) equipment which has all the capabilities of legacy ADMs, but can also include cross-connect functionality to manage multiple fiber rings in a single chassis. These new devices can replace multiple legacy ADMs and also allow connections directly from Ethernet LANs to a service provider's optical backbone. In the end of 2003, sales of multiservice ADMs exceeded those of legacy ADMs for the first time, as the change to next-generation SONET/SDH networks accelerated.

An emerging variety of ADMs that is becoming popular as the carriers continue to invest in metro optical networks are reconfigurable optical add-drop multiplexers (ROADMs). A reconfigurable optical add-drop multiplexer (ROADM), is a form of optical add-drop multiplexer that adds an ability to remotely switch traffic from a WDM system at the wavelength layer. This allows individual wavelengths carrying data channels to be added and dropped from a transport fiber without the need to convert the signals on all of the WDM channels to electronic signals and back again to optical signals.

Some main advantages of the ROADM include:

The planning of entire bandwidth assignment need not be carried during initial deployment of a system. The configuration can be done as and when required. ROADM allows for remote configuration and reconfiguration. In ROADM, as it is not clear beforehand where a signal can be potentially routed, there is a necessity of power balancing of these signals. ROADMs allow for automatic power balancing.

ROADM functionality originally appeared in long-haul DWDM equipment, but by 2005, it began to appear in metro optical systems because of a need to build out major metropolitan networks to deal with the traffic driven by the increasing demand for packet-based services.

The switching or reconfiguration functions of a ROADM have been achieved using a variety of switching technologies including MEMS, Liquid crystal and thermo optic switches in planar waveguide circuits.

What is needed is an optical switching technology suitable for use in applications such as ROADM that is faster, less expensive, and more efficient than existing technologies. What is further needed is adaptation of electro-optical micro-ring oscillators to incorporate magneto-optic switching technology for a magneto-optic micro-ring oscillator.

### BRIEF SUMMARY OF THE INVENTION

Disclosed is an apparatus, method, system, and computer-program product for producing magneto-optic (MO) materials in blue and green light wavelengths. The apparatus includes a substrate generally transparent to a light signal including a component at a predetermined visible frequency; a stack of optical multilayers overlying the substrate for transmitting the component with at least about forty percent power there through and having at least about twenty-four degrees of Faraday rotation per micron for the predetermined visible frequency less than about six hundred nanometers. The method includes processes for the manufacture and assembly of the disclosed materials, with the computer program product including machine-executable instructions for carrying out the disclosed methods. These materials may be adapted for other wavelengths including red, infrared and other frequencies including those used for communication applications.

Also disclosed is an apparatus, method, system, and computer-program product for a magneto-optic switching. An MO switching apparatus includes a first waveguide supporting a propagation of a radiation signal from a first port to a second port; a second waveguide including a second port; and a ring-oscillator having a closed propagation pathway including magneto-optic materials, said ring-oscillator operationally coupled to said waveguides and responsive to a controlling influence to switch between a first mode and a second mode, with said first mode substantially non-interfering with said propagation of said radiation signal in said first waveguide and with said second mode routing said propagation of said radiation signal from said first port to said second port. Methods of making and using, as well as computer program products including instructions for causing\implementing\initiating manufacturing and use of magneto-optic switching technologies.

Magneto-optic materials compatible with magneto-optic displays and projection systems are realized. The disclosed materials enable simple, efficient, and economical multicolored displays employing the red, green, and blue (RGB) primary color paradigm.

### BRIEF DESCRIPTION OF THE DRAWINGS

FIG. 1 is a generic representation of a preferred embodiment for a multilayer magneto-optic photonic crystal (MPC) modulating system according to the present invention;

FIG. 2 is a first specific embodiment for an MPC according to the present invention;

FIG. 3 is a second specific embodiment for an MPC according to the present invention;

FIG. 4 is a third specific embodiment for an MPC according to the present invention;

FIG. 5 is preferred embodiment for an alternative layer arrangement in an MPC according to the present invention;

FIG. 6 is a set of graphs of transmission and faraday rotation spectra for the structure of FIG. 2;

FIG. 7 is a set of graphs of transmission and faraday rotation spectra for the structure of FIG. 3;

FIG. 8 is a set of graphs of transmission and faraday rotation spectra for the structure of FIG. 4;

FIG. 9 is a view of a conventional electro-optical micro-ring oscillator;

FIG. 10 is an embodiment of a magneto-optic ring oscillator to provide a 1×4 magneto-optic optical router;

FIG. 11 is a graph illustrating spectral split of a propagating signal in the router shown in FIG. 10;

FIG. 12 is a preferred embodiment for a magnitude distribution system;

FIG. 13 through FIG. 17 are a series of block diagrams resulting from completion of a series of processing events on a substrate;

FIG. 13 is a side plan view and top plan view of substrate;

FIG. 14 is a side plan view and top plan view of a metal (ground) deposition;

FIG. 15 is a side plan view and top plan view of a magneto-optic film production;

FIG. 16 is a side plan view and top plan view of a selective magneto-optic film removal;

FIG. 17 is a side plan view and top plan view of a selective second metal (core) production;

FIG. 18 through FIG. 21 are a series of block diagrams resulting from completion of a second series of processing events on a substrate including VLSI circuitry;

FIG. 18 is a side plan view and top plan view of substrate including VLSI circuitry;

FIG. 19 is a side plan view and top plan view of a metal (ground) and waveguide production;

FIG. 20 is a side plan view and top plan view of a magneto-optic micro-ring production;

FIG. 21 is a side plan view and top plan view of a selective second metal (core) production;

FIG. 22 through FIG. 26 are a series of block diagrams resulting from completion of a series of processing events on a substrate including VLSI circuitry;

FIG. 22 is a side plan view and top plan view of substrate including VLSI circuitry;

FIG. 23 is a side plan view and top plan view of a metal (ground) and Si3N4 waveguide formation;

FIG. 24 is a side plan view and top plan view of an SiO2 production burying the Si3N4 waveguides;

FIG. 25 is a side plan view and top plan view of a magneto-optic film production and selective removal;

FIG. 26 is a side plan view and top plan view of a selective second metal (core) production;

FIG. 27 is a representative embodiment of a magneto-optic micro-ring 1×4 optical router disposed on a printed circuit board; and

FIG. 28 is a schematic diagram of a ROADM implemented using a planar MPC-based optical shutter.

### DETAILED DESCRIPTION OF THE INVENTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

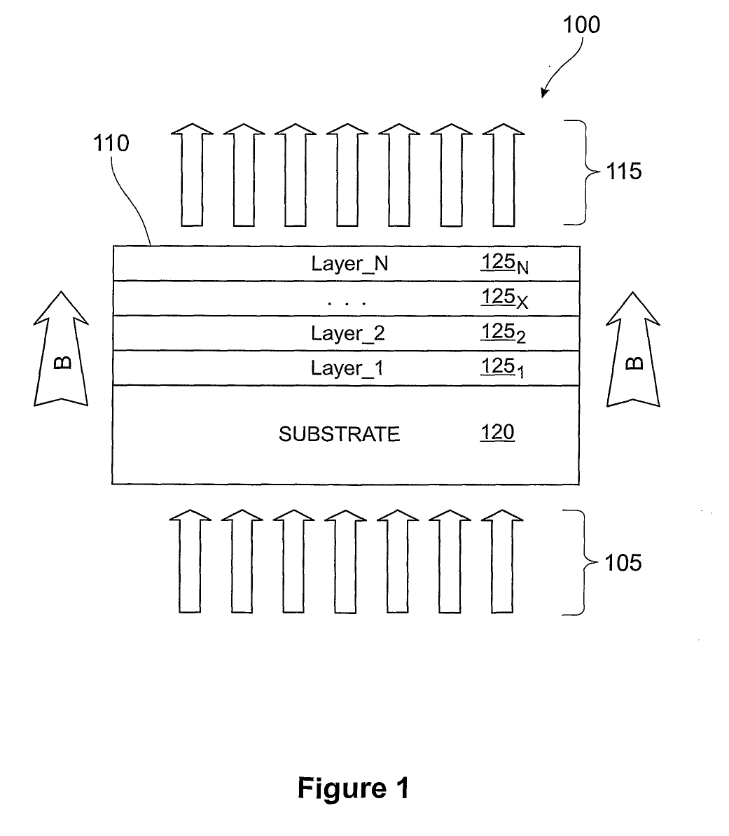

FIG. 1 is a generic representation of a preferred embodiment for a multilayer magneto-optic photonic crystal (MPC) modulating system 100 according to the present invention. MPC modulating system 100 is typically a planar structure having an input side for receiving polarized (e.g., one of right-hand circularly polarized or left-hand circularly polarized light) radiation 105, an MPC structure 110, and an output side for transmitting the polarized light with a different magnitude of polarization rotation 115 effected by a magnetic field (B) imposed on the radiation parallel to the propagation direction of the radiation (e.g., Faraday Effect).

MPC 110 includes a substrate 120 supporting N number of layers (120ᵢ, i=1 to N) of materials of particular thickness and magneto-optic properties having the desired MPC characteristics as will be described later. By appropriate structuring of layers 120, transmissivity and gyration properties (a measurement of polarization response to the imposed magnetic field B) are achieved for a desired wavelength of input radiation 105.

There are many different ways by which MPC 110 may be manufactured—the preferred embodiment includes the following process steps (though the invention is not intended to be limited to structures made with this process). The process starts with a Gadolinium Gallium Garnet (GGG) or other appropriate supporting substrate (e.g., silicon and the like) depending upon the wavelength and desired material properties and composition of layers 120. Size of the substrate depends upon the anticipated use and the number of pixels to be formed in the bulk device—for example 10 mm×10 mm for 128×128 pixel module and approximately 100 mm×50 mm for a 4096×2048 pixel module in the preferred embodiment for an MPC to be used in a projector system having each pixel surrounded by a magnetic field generating conductive array. These dimensions of course may be adapted and altered for any particular use.

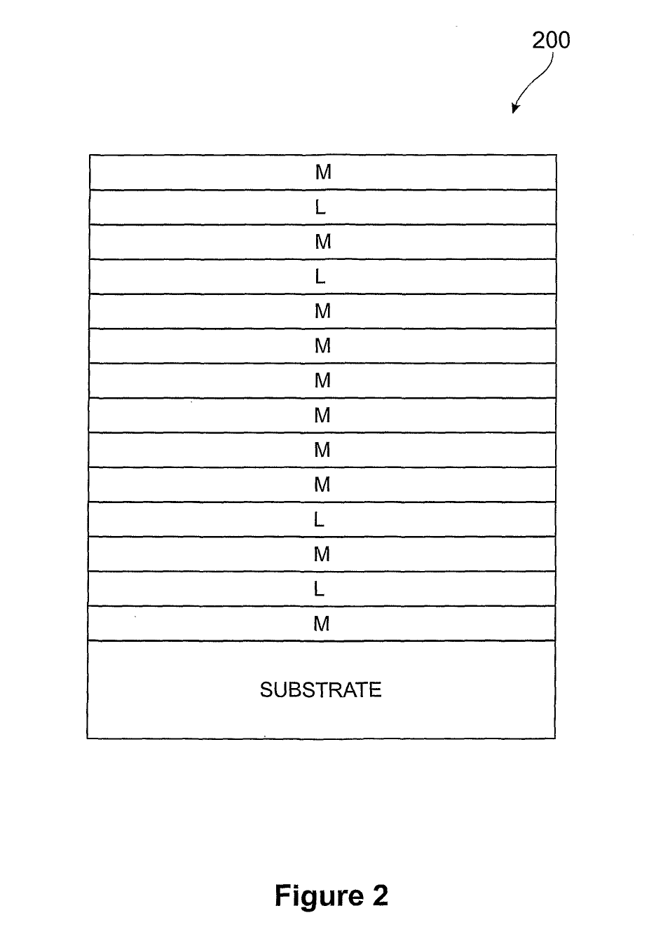

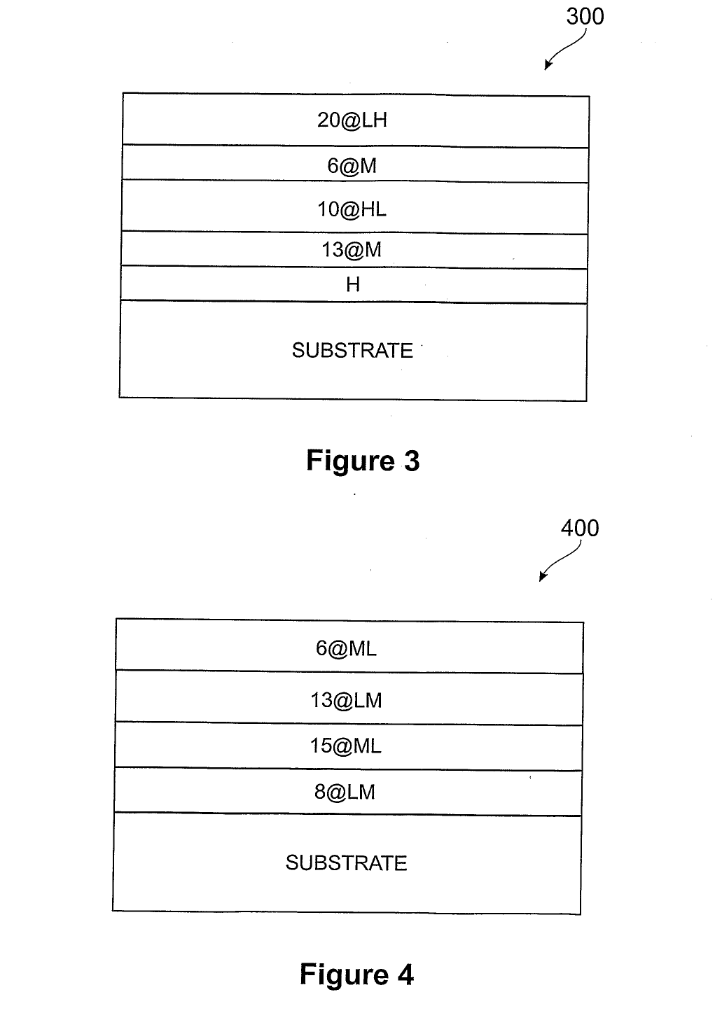

A preferred manufacturing process includes sputtering multilayers of magnetic and non-magnetic materials of different thicknesses dependent on structure and wavelength as illustrated in FIG. 2, FIG. 3, and FIG. 4 for example. While radiofrequency sputtering is preferred to produce layers 120, other layering techniques are well-known and may be used instead or in conjunction, depending upon the needs and desires of the specific implementation. As will be explained further below, the preferred embodiment provides each layer 120× with a thickness dependent upon the wavelength of the transmitted light. It is also understood that the following representative preferred structures are designed for a blue wavelength to improve transmissivity and gyration at these wavelength. In the following discussion, we use the following wavelengths to correspond to blue, green, and red: for a blue module, λ=473 nm, for a green module, λ=532 nm, and for a red module, λ=632 nm.

Sputtering is a physical process whereby atoms in a solid target material are ejected into the gas phase due to bombardment of the material by energetic ions. It is commonly used for thin-film deposition, as well as analytical techniques. Sputtering is largely driven by momentum exchange between the ions and atoms in the material, due to collisions. The process can be thought of as atomic billiards, with the ion (cue ball) striking a large cluster of close-packed atoms (billiard balls). Although the first collision pushes atoms deeper into the cluster, subsequent collisions between the atoms result in some of the atoms near the surface being ejected away from the cluster. The number of atoms ejected from the surface per incident ion is called the sputter yield and is an important measure of the efficiency of the sputtering process. Other things the sputter yield depends on are the energy of the incident ions, the masses of the ions and target atoms, and the binding energy of atoms in the solid. The ions for the sputtering process are supplied by a plasma that is induced in the sputtering equipment. In practice a variety of techniques are used to modify the plasma properties, especially ion density, to achieve the optimum sputtering conditions, including usage of RF (radio frequency) alternating current, utilization of magnetic fields, and application of a bias voltage to the target.

Sputtered atoms ejected into the gas phase are not in their thermodynamic equilibrium state. Deposition of the sputtered material tends to occur on all surfaces inside the vacuum chamber. Sputtering is used extensively in the semiconductor industry to deposit thin films of various materials in integrated circuit processing. Thin antireflection coatings on glass for optical applications are also deposited by sputtering. Because of the low substrate temperatures used, sputtering is an ideal method for depositing contact metals for thin-film transistors. Perhaps the most familiar products of sputtering are low-emissivity coatings on glass, used in double-pane window assemblies. The coating is a multilayer containing silver and metal oxides such as zinc oxide, tin oxide, or titanium dioxide.

One important advantage of sputtering as a deposition technique is that the deposited films have the same composition as the source material. The equality of the film and target stoichiometry might be surprising since the sputter yield depends on the atomic weight of the atoms in the target. One might therefore expect one component of an alloy or mixture to sputter faster than the other components, leading to an enrichment of that component in the deposit. However, since only surface atoms can be sputtered, the faster ejection of one element leaves the surface enriched with the others, effectively counteracting the difference in sputter rates. In contrast with thermal evaporation techniques one component of the source may have a higher vapor pressure, resulting in a deposited film with a different composition than the source.

Sputter deposition also has an advantage over molecular beam epitaxy (MBE) due to its speed. The higher rate of deposition results in lower impurity incorporation because fewer impurities are able to reach the surface of the substrate in the same amount of time. Sputtering methods are consequently able to use process gases with far higher impurity concentrations than the vacuum pressure that MBE methods can tolerate. During sputter deposition the substrate may be bombarded by energetic ions and neutral atoms. Ions can be deflected with a substrate bias and neutral bombardment can be minimized by off-axis sputtering, but only at a cost in deposition rate. Plastic substrates cannot tolerate the bombardment and are usually coated via evaporation.

Sputter guns are usually magnetrons that depend on strong electric and magnetic fields. The sputter gas is inert, typically argon. The sputtering process can be disrupted by other electric or magnetic fields in the vicinity of the target. Charge build-up on insulating targets can be avoided with the use of RF sputtering where the sign of the anode-cathode bias is varied at a high rate. RF sputtering works well to produce highly insulating oxide films but only with the added expense of RF power supplies and impedance matching networks. Stray magnetic fields leaking from ferromagnetic targets also disturb the sputtering process. Specially designed sputter guns with unusually strong permanent magnets must often be used in compensation.

Ion-beam sputtering (IBS) is a method in which the target is external to the ion source. In a Kaufman source ions are generated by collisions with electrons that are confined by a magnetic field as in a magnetron. They are then accelerated by the electric field emanating from a grid toward a target. As the ions leave the source they are neutralized by electrons from a second external filament. IBS has an advantage in that the energy and flux of ions can be controlled independently. Since the flux that strikes the target is composed of neutral atoms, either insulating or conducting targets can be sputtered. IBS has found application in the manufacture of thin-film heads for disk drives. The principal drawback of IBS is the large amount of maintenance required to keep the ion source operating.

Reactive sputtering refers to a technique where the deposited film is formed by chemical reaction between the target material and a gas which is introduced into the vacuum chamber. Oxide and nitride films are often fabricated using reactive sputtering. The composition of the film can be controlled by varying the relative pressures of the inert and reactive gases. Film stoichiometry is an important parameter for optimizing functional properties like the stress in SiNx and the index of refraction of SiOₓ. The transparent indium tin oxide conductor that is used in optoelectronics and solar cells is made by reactive sputtering.

In ion-assisted deposition (IAD) the substrate is exposed to a secondary ion beam operating at a lower power than the sputter gun. Usually a Kaufman source like that used in IBS supplies the secondary beam. IAD can be used to deposit carbon in diamond-like form on a substrate. Any carbon atoms landing on the substrate which fail to bond properly in the diamond crystal lattice will be knocked off by the secondary beam. NASA used this technique to experiment with depositing diamond films on turbine blades in the 1980's. IAS is used in other important industrial applications such as creating tetrahedral amorphous carbon surface coatings on hard disk platters and hard transition metal nitride coatings on medical implants.

Epitaxy is a specialized thin-film deposition technique. The term epitaxy (Greek; “epi” “equal” and “taxis” “in ordered manner”) describes an ordered crystalline growth on a (single-) crystalline substrate. It involves the growth of crystals of one material on the crystal face of another (heteroepitaxy) or the same (homoepitaxy) material. Epitaxy forms a thin film whose material lattice structure and orientation or lattice symmetry is identical to that of the substrate on which it is deposited. Most importantly, when the substrate is a single crystal, then the thin film will also be a single crystal. Contrast with self-assembled monolayer and mesotaxy.

Self assembled monolayers are surfaces consisting of a single layer of molecules on a substrate. Rather than having to use a technique such as chemical vapor deposition or molecular beam epitaxy to add molecules to a surface (often with poor control over the thickness of the molecular layer), self assembled monolayers can be prepared simply by adding a solution of the desired molecule onto the substrate surface and washing off the excess.

A common example is an alkane thiol on gold. Sulfur has particular affinity for gold and an alkane with a thiol head group will stick to the gold surface with the alkane tail pointing away from the substrate.

Mesotaxy is the term for the growth of a crystallographically matching phase underneath the surface of the host crystal (compare to epitaxy, which is the growth of the matching phase on the surface of a substrate). In this process, ions are implanted at a high enough energy and dose into a material to create a layer of a second phase, and the temperature is controlled so that the crystal structure of the target is not destroyed. The crystal orientation of the layer can be engineered to match that of the target, even though the exact crystal structure and lattice constant may be very different. For example, after the implantation of nickel ions into a silicon wafer, a layer of nickel silicide can be grown in which the crystal orientation of the silicide matches that of the silicon.

Some examples of epitaxy are molecular beam epitaxy, liquid phase epitaxy and vapor phase epitaxy. It has applications in nanotechnology and in the manufacture of semiconductor and photonic devices. Indeed, epitaxy is the only affordable method of high crystalline quality growth for many semiconductor materials, including the technologically important materials as SiGe, gallium nitride, gallium arsenide and indium phosphide, the latter used in devices for LEDs and telecommunications.

In the preferred embodiment, sputtering targets can be commercially available or custom made, and designed for the number and type/composition of the layers 120. In structures shown in FIG. 2 through FIG. 4, the maximum number of required sputtering targets is 3. However, in other embodiments and implementations, it may be more than this number, e.g. 6-8 (or more or less), will be used to achieve alternative preferred structures.

FIG. 2 is a first specific preferred embodiment for an MPC 200 according to the present invention. FIG. 6 is a set of graphs of transmission and faraday rotation spectra for the structure of FIG. 2. MPC 200 includes a substrate of GGG and layers of two materials designated “M” and “L” where M is bismuth substituted yttrium iron-garnet (Bi:YIG) and L is the same as the substrate—namely GGG. The design wavelength for MPC 200 is 473 nm and each layer has a thickness approximately equal to λ/4 n, where n is the index for the specific layer material (e.g., n(L) is about 1.97 and n(M) is about 2.8). Thus a thickness of each of the L layers is about 60.02 nm and a thickness of each of the M layers is about 42.23 nm for a total thickness of all layers of about 662.4 nm. For simplicity, the arrangement of the layers of MPC 200 is described according to the sequence: S(ML)2(M)6(LM)2 signifying that there are a total of 4 L layers and 10 M layers on top of the substrate, arranged as shown in FIG. 2. Note that in some deposition or layering systems, the (M)6 section of MPC 200 may either be 6 independent layers of M, one layer of M 6*42.23 nm thick, or some combination of layers producing the same or similar result. MPC 200, structured as shown, produces a gyration of 0.04-0.2 i (providing an intrinsic rotation of about 24 degrees/micron). Absorption—α(M) is about 7000 cm⁻¹ and α(L) is about 100 cm⁻¹—and the standard deviation for the thickness for all layers is about 0.5 nm (˜1%).

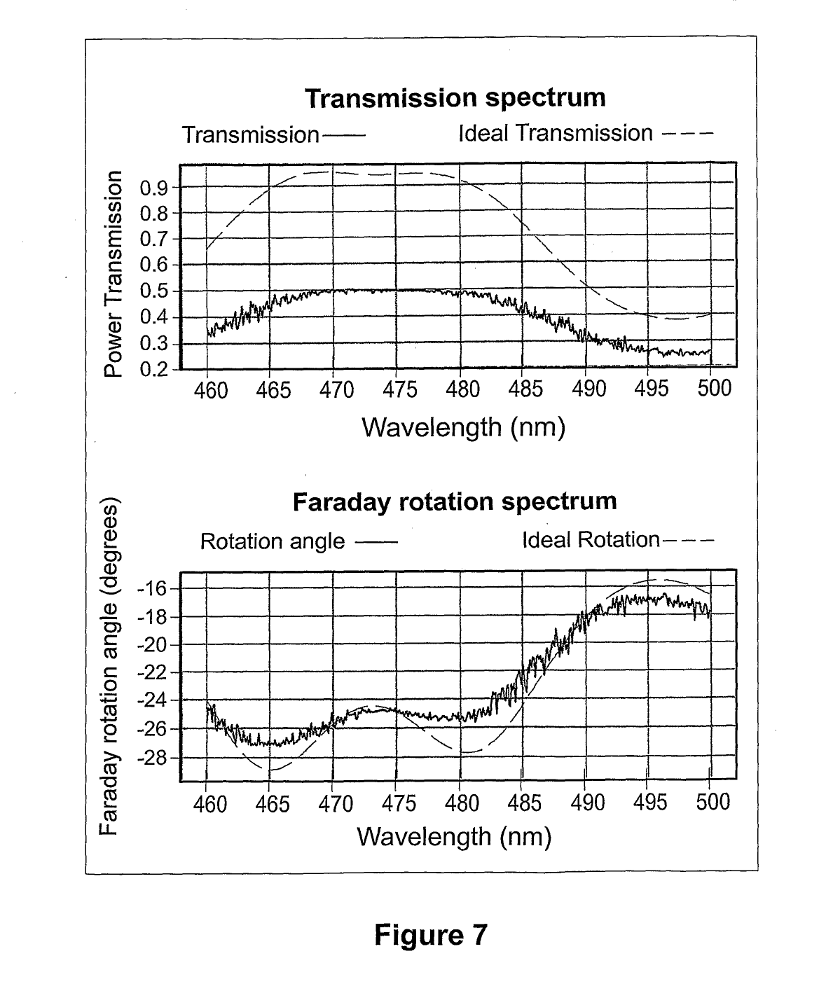

FIG. 3 is a second specific preferred embodiment for an MPC 300 according to the present invention. FIG. 7 is a set of graphs of transmission and Faraday rotation spectra for the structure of FIG. 3. MPC 300 includes a substrate of SiO₂ (or in some cases GGG) and layers of three materials designated “M” and “L” and “H” where M is Bi₃Fe₅O₁₂ (alternatively Ce-doped) with good specific Faraday rotation and L is GGG and H is ZnO and/or Ta₂O₅. The design wavelength for MPC 300 is also 473 nm and each layer has a thickness approximately equal to λ/4 n, where n is the index for the specific layer material (e.g., n(substrate)=2.1, n(L) is about 1.9, n(M) is about 2.8, and n(H) is about 2.0. Thus a thickness of each of the L layers is about 62.23 nm, a thickness of each of the M layers is about 42.23 nm, and a thickness of each of the H layers is about 59.12 nm for a total thickness of all layers of about 2300 nm. For simplicity, the arrangement of the layers of MPC 300 is described according to the sequence: S(H)1(M)13(HL)10(M)6(LH)2 signifying that there are a total of 12 L layers, 19 M layers and 13H layers on top of the substrate, arranged as shown in FIG. 3. Note that in FIG. 3, for convenience that a schema for identifying the layers is used as 10@HL meaning that there are 10 sequences of the H and L alternating layers in that portion of MPC 300. Absorption—α(M) is about 7000 cm⁻¹ and α(L) is about 100 cm⁻¹.

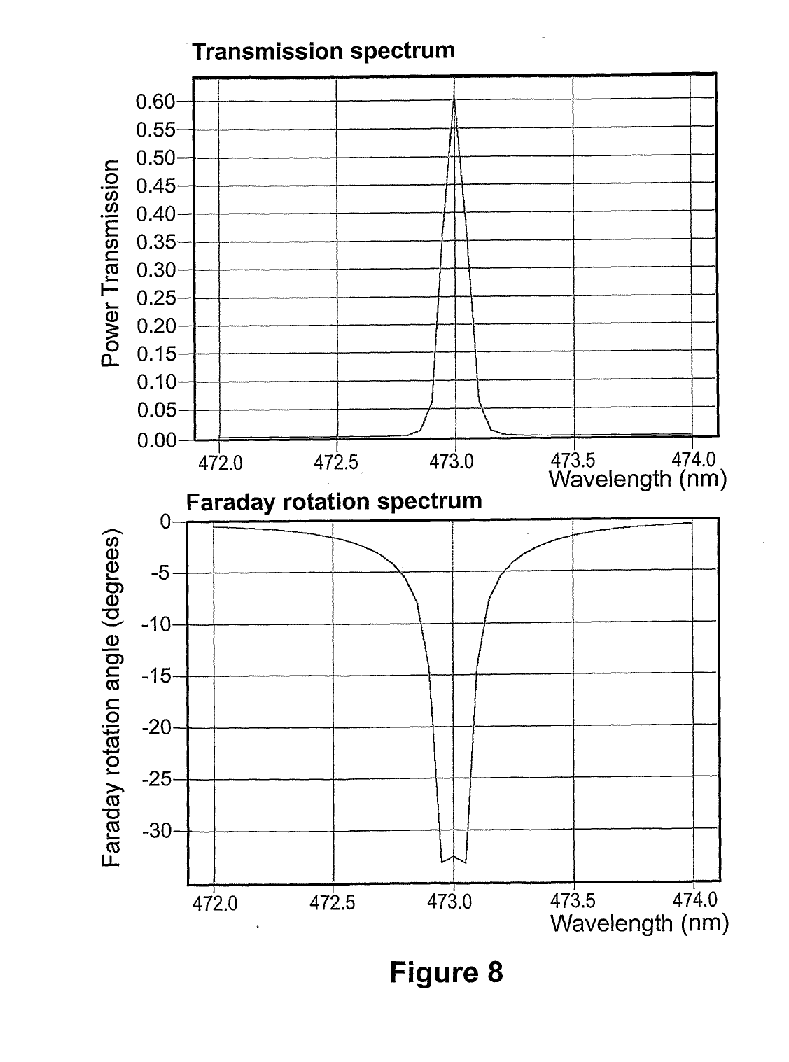

FIG. 4 is a third specific preferred embodiment for an MPC 400 according to the present invention. FIG. 8 is a set of graphs of transmission and Faraday rotation spectra for the structure of FIG. 4. MPC 400 includes a substrate of SiO₂ (or in some cases GGG) and layers of two materials designated “M” and “L” where M is paramagnetic CdMnTe and L is SiO₂. The design wavelength for MPC 400 is also 473 nm and each layer has a thickness approximately equal to λ/4 n, where n is the index for the specific layer material (e.g., n(substrate)=n(L) is about 1.5, n(M) is taken to be about 2.5 for a total thickness of about 5.3 microns. For simplicity, the arrangement of the layers of MPC 400 is described according to the sequence: S(LM)8(ML)15(LM)13(ML)6 signifying that there are a total of 39 L and M layers, arranged as shown in FIG. 4. Note that in FIG. 4, for convenience that a schema for identifying the layers is used as 8@LM meaning that there are 8 sequences of the L and M alternating layers in that portion of MPC 400. Absorption—α(M) is about 20 cm⁻¹ and α(L) is about 0 cm⁻¹.

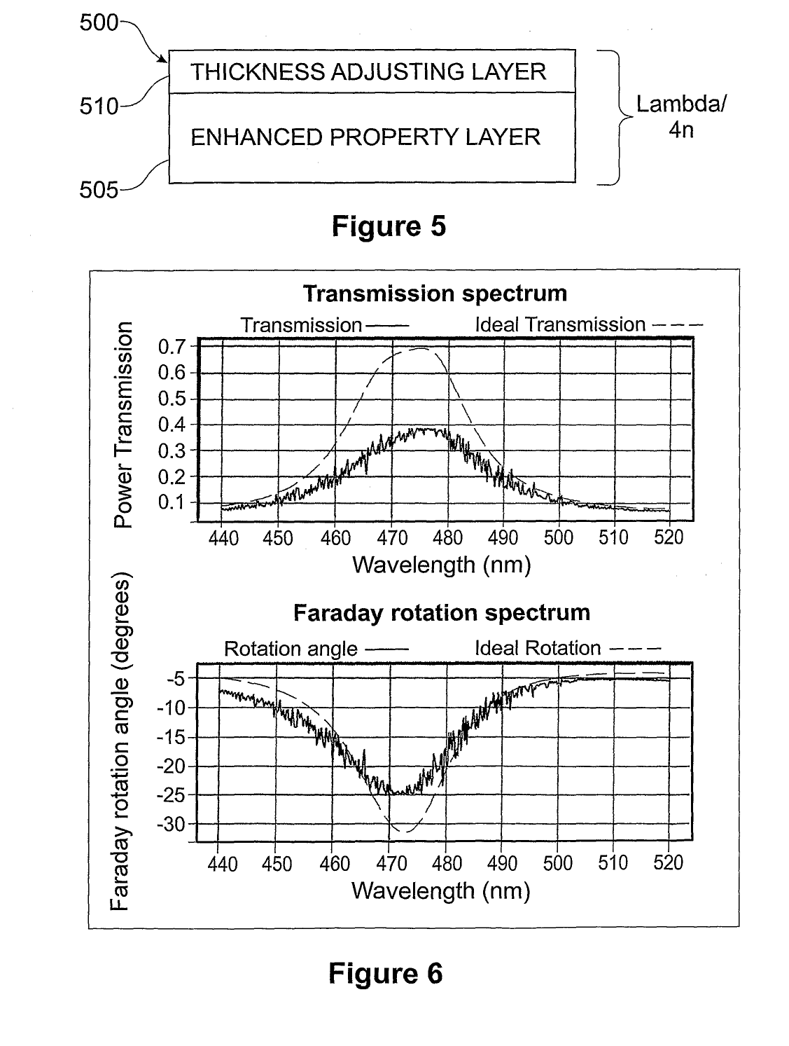

FIG. 5 is a preferred embodiment for an alternative layer arrangement in an MPC according to the present invention. Some reported measurements have shown that thin (10-30 nm) cobalt (Co) films have lower loss coefficient in comparison to thicker films. This phenomenon is attributed to a tunneling effect (wave will tunnel through the film and appear outside) and some implementations are believed to be suitable for multi-pass in an MPC. Co has Faraday rotation about 50 times greater than Bi:YIG (saturated intrinsic rotation is 36.3 deg/micron at H=1.78 Tesla). An MPC consisting of layers of Co (10-20 nm) and dielectric layers may be an efficient approach for both high Faraday rotation and adequate transmission, especially considering that rotation of Co is stronger at shorter wavelengths (blue).

In order to include such a material in an MPC, it may be necessary or desirable to supplement any given sublayer, such as the use of a magnetooptic material film or an inert/transparent film or the like, to produce a layer having a total overall thickness of λ/4 n.

In FIG. 5, a layer 500 of an MPC is shown including an enhanced property layer 505 and a thickness-adjusting layer 510 (while other configurations having more than 2 layers is also possible wherein different attributes for transmissivity and gyration are provided by multiple sublayers to produce a single layer, such as for example use in an MPC shown in FIG. 1 through FIG. 4. In one case, sublayer 505 is a cobalt thin film and sublayer 510 includes a GGG or SiO₂ layer. In other cases, sublayer 505 may be the paramagnetic material CdMnTe and sublayer 510 may be Bi:YIG. Such a layer 500 of the CdMnTe/Bi:YIG may be used as the M layer in an MPC, such as in MPC 400 shown in FIG. 4.

To build magneto-optic BLUE (hereinafter MO-B) and GREEN (MO-G) modules, a heteroepitaxial all-garnet film processing technology based on Ca-doped Bi₃Fe₅O₁₂ (hereinafter Ca:BIG), Ce-doped Y₃Fe₅O₁₂ (Ce:YIG), and Ga-doped Bi₃Fe₅O₁₂ (Ga:BIG) garnet materials has been developed. Ca- and Ga-doping enable the enhancement of optical transparency whereas the Ce-doping results in a strong blue-shift of the absorption edge and Faraday rotation (FR). Fabricating and optimizing MO-photonic crystals has included use of a “combinatorial” approach combining various garnet compositions, various material sequences and number of layers both in the central optical cavity as well as in dielectric mirrors. The main representatives of the photonic crystals possessing good MO-performance are presented in Table I below.

TABLE I

| | | λ/2 Optical Cavity | | | |
|---|---|---|---|---|---|
| | | | Ca:BIG/ | | |
| | | Ca:BIG | GGG | Ga:BIG | Ce:BIG |
| Mirrors | Ca:BIG/ | MO-G1 | MO-G3 | | |
| | GGG | | | | |
| | Ga:BIG/ | | | MO-G4, MO- | |
| | GGG | | | G6 | |
| | Ce:YIG/ | | | MO-G5 | MO-B1, MO- |
| | GGG | | | | B2, MO-B3 |
| | YIG/GGG | | | MO-G2 | |

The names of the photonic crystals MO-Bi or MO-Gi notify BLUE or GREEN light operational range while i is the sample number. All the photonic crystals, except MO-G3 and MO-G6, have the homogeneous central optical cavity with the thickness λ/2 n and dielectric λ/4 n mirrors where the n is the refraction index of the corresponding garnet material. The optical cavity in MO-G3 crystal has been fabricated as a sequence of five Ca:BIG and GGG layers which thicknesses satisfy the following condition:

d_{Ca:BIG}×n_{Ca:BIG}(λ)+d_{GGG}×n_{GGG}(λ)=λ/2

where λ is the designed wavelength. Also, the Ca:BIG/GGG/Ca:BIG/GGG/Ca:BIG five layer sequence has been fabricated using the following number of laser pulses 100/656/1000/656/100, respectively. To make mirrors more transparent in MO-G6 crystal, they have been built using the stack of λ/8 nGa:BIG thick Ga:BIG and 3λ/8 nGGG thick GGG garnets.

It is seen from FIG. 6 through FIG. 8 that significant enhancement of the Faraday rotation has been achieved in magneto-optic photonic crystals. The fabricated crystals have a limited number of the dielectric mirrors, however a strong rejection of the light within the band gap has been demonstrated both for MO-G and MO-B modules. A distinctive feature of the MO-B modules is the positive Faraday rotation utilized in Ce:YIG material. The structures demonstrate the feasibility to use Ce:YIG garnet as well as Ca:BIG and Ga:BIG garnets for MO-B and MO-G modules, respectively.

Note that in some instances, various results for transmission and gyration/rotation are described. In most cases, the results are based upon measured results taken from structures produced using pulsed laser deposition. It is understood that some of the other manufacturing techniques, including RF Magnetron Sputtering and molecular beam epitaxy (MBE) generally produce improved results due to the quality of the manufactured layers. For example, in some cases, RF magnetron sputtering results in at least half absorption coefficients in comparison to Pulsed Laser Deposition (PLD). Liquid Phase Epitaxy (LPE) results in around half absorption coefficients with respect to RF sputtering.

For example, using PLD to synthesize an optimized RED MPC structure S(ML)1(MM)10(LM)3(MM)11(ML)6(LM)4, the M layers (BIG) would have an absorption coefficient (for example) A=2800 cm̂−1 and gyration −0.035, resulting in a transmission of 21.9% and Faraday rotation of 18.7 degrees (that is a dynamic range of 8.1%=transmittance*sin(2*rotation)̂2). When RF magnetron sputtering is used, the absorption coefficient of the M layers becomes at most A=1400 cm̂−1 and the gyration stays the same (−0.035), resulting in an optimized structure S(ML)2(MM)8(LM)5(MM)9(ML)8(LM)5 of transmission of 29.6% and Faraday rotation of 29.5 degrees (that is a dynamic range of 21.7%).

Table II and Table III below include comparisons between PLD and sputtered RGB MPC structures. For PLD MPCs, measured absorption coefficients and Faraday rotations were used. For sputtered MPCs, absorption coefficients were selected are as shown. Note that LPE is currently practical only for planar structures. In Table III, the columns include wavelength, transmittance, rotation, dynamic range, thickness, MPC structure, absorption, and deposition type (i.e., pulsed laser deposition, RF sputtering, and liquid phase epitaxy). In Table III, rows having transmittance prefaced with a “*” are measured results, the others are results from a simulation. The type of structure used to obtain the values corresponds generally to FIG. 2 of the incorporated 60/766,764 patent application. Gyration values for the entries in Table III include g=0.035 for a BIG/GGG structure used with red; g=0.05 for a BIG/GGG structure used with green, g=0.01 for a Ce-YIG/BBB structure used with blue, and g=0.27 for a BIG/air structure used with planar structures as shown (PS=planar structures).

TABLE II

| | | | | Dynamic |
|---|---|---|---|---|
| Wavelength | | | Rotation | Range = Transmittance * |
| (nm) | | Transmittance | (deg) | Sin(2 * Rotation)\hat{ }2 |
| RED | @ 673 | 45% | 5.1 | 1.42 |
| | @ 657 | 41% | 5.7 | 1.60 |
| | @ 676 | 46% | 5.2 | 1.50 |
| | @ 678 | 47% | 5.1 | 1.47 |
| | @ 738 | 39% | 7.5 | 2.61 |
| | @ 770 | 43% | 6.6 | 2.24 |
| | @ 825 | 46% | 4.4 | 1.08 |
| GREEN | @ 594 | 41% | 5.6 | 1.55 |
| | @ 571 | 31% | 6.7 | 1.66 |
| | @ 588 | 41% | 5.8 | 1.66 |
| | @ 581 | 36% | 5.8 | 1.45 |
| BLUE | @ 467 | 33% | 1.9 | 0.14 |
| | @ 473 | 35% | 1.9 | 0.15 |
| | @ 475 | 35% | 2 | 0.17 |
| | @ 475 | 22% | 2.4 | 0.15 |

TABLE III

| λ | | | Range | d | | A | |
|---|---|---|---|---|---|---|---|
| (nm) | T % | Rot. | % | (um) | MPC structure | (cm\hat{ }−1) | Depo |
| 738 | *40 | 7.5 | 2.68 | 1.43 | S(ML)4(M)2(LM)4 | 2800 | PLD |
| 738 | 21 | 16.2 | 5.94 | 4.6 | S(MM)11(ML)4(LM)9(ML)6 | 2800 | PLD |
| 635 | 30.3 | 14.8 | 7.39 | 3.14 | S(ML)1(MM)10(LM)4(MM)6(ML)4 | 2800 | PLD |
| 635 | 21.9 | 18.7 | 8.07 | 4.42 | S(ML)1(MM)10(LM)3(MM)11(ML)6(LM)4 | 2800 | PLD |
| 635 | 29.6 | 29.5 | 21.73 | 4.2 | S(ML)1(MM)9(LM)3(MM)7(ML)6(LM)3 | 1400 | RFS |
| 540 | *20.0 | 6 | 0.86 | 0.8 | S(ML)3(MM)1(LM)3 | 17000 | PLD |
| 540 | 22.8 | 17.1 | 7.20 | 2.96 | S(LM)4(ML)8(LM)8(ML)5 | 5000 | RFS |
| 540 | 20.4 | 18.5 | 7.38 | 3 | S(ML)3(LM)5(MM)10(ML)6(LM)3 | 5000 | RFS |
| 470 | *28.0 | 2.1 | 0.15 | 0.89 | S(ML)4(MM)1(LM)4 | 5500 | PLD |
| 470 | 16.1 | 4.3 | 0.36 | 2.57 | S(ML)1(MM)10(LM)5(ML)8(LM)3 | 5500 | PLD |
| 470 | 18.5 | 10.3 | 2.29 | 3.07 | S(MM)10(LM)6(ML)9(MM)6(LM)2 | 2000 | RFS |
| PS | | | | | | | |
| 470 | 49 | 36.1 | 44.13 | 1.4 | S(MM)11(LL)12(MM)82(LL)12(MM)11 | 7000 | LPE |

Thicknesses of L and M = λ/4

As seen above, the chosen processing technique for production of the layers of these “multistacks” may influence the final device arrangement. Described above, there may be an implication that all the layers are produced using the same processing technique. Further, described above is one layer attribute, namely thickness, which is described as having a functional relationship to one type of design parameter, namely wavelength. As a generic description of the stack structures as an aid to explanation, there is a certain similarity between the described multistacks and a Fabry-Perot cavity. For example, the multistacks include sets of layers that have different functionality—for example the relatively thin outer layers may act as reflective “mirror” elements and the collection of middle layers may function as the “active” cavity for interacting with the propagating radiation in the desired way. For this model, it may be desirable to have different layer attributes and design parameters for the sets of layers or even of the individual layers. Other models may be used for a multi-stack structure and different sets of layers may be tuned for one or more different attributes and/or with one or more different design parameters.

Different attributes and design parameters may be important for different layers. For example, previous examples teach a relationship between wavelength and layer thickness. Crystal grain size for at least some layers (e.g., in the active cavity) is believed important in improving transmittance by reducing diffusion and/or absorption through reducing grain size of the crystals in these layers). Other examples may include controlling dopant concentrations/distributions in a layer as well as across multiple layers. Thus each layer and the collection of layers are subjected to atomic engineering using processes tuned for, and efficient with, the desired attribute/design parameter.

It is desirable in these cases to produce different layers with different attributes and to provide for different classes of processing techniques for the different layers to achieve the different attributes/design parameters. For example, sputtering may be used to produce one set of layers because of the ease of accurately controlling thicknesses of each layer and epitaxy processing may be used for producing another set of layers because of the ease of accurately controlling crystal grain size. (Note as used herein, different classes of processing techniques do not encompass variations within a specific type of technique—RF sputtering uses different targets for different layers, but all the layers are made with the same class of manufacturing technique for purposes of the present invention.) The different classes of processing techniques are used to optimize performance while making use of the individual efficiencies of the different processing techniques with respect to different layers of a magneto-optic material. While the above discussion was particularly directed to magneto-optic materials optimized for blue and green visible wavelengths, the present invention may be adapted to a broader range of frequencies, particularly to those in the red, near-infrared, and infrared frequencies, as well as other frequencies including communications frequencies such as those developed from lasers and the like.

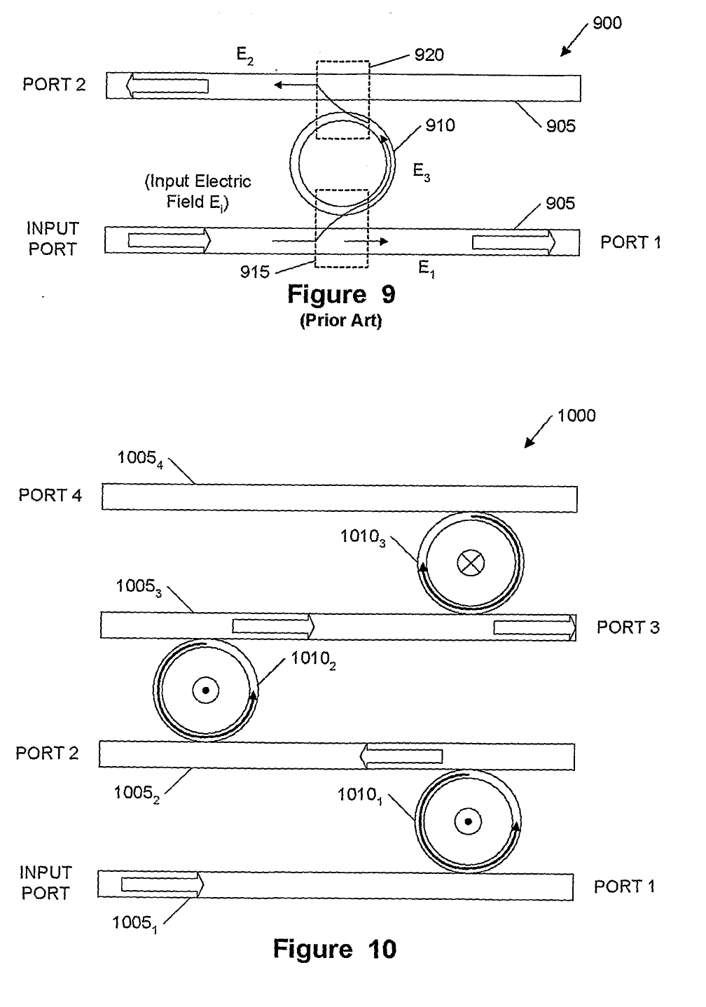

FIG. 9 is a view of a conventional electro-optical micro-ring oscillator 900. Oscillator 900 includes a planar structure including a pair of waveguides 905 with a central optical ring 910, a first coupler 915 coupling a first waveguide 905 to ring 910 and a second coupler 920 coupling ring 910 to a second waveguide 905. An input electric field Ej and three routing electric fields (E1, E2, and E3) control a magnitude of a radiation signal propagating in the identified portions of oscillator 900, where E₁=\sqrt{1−κ}·Eᵢ, E₂=j·\sqrt{κ}·E₃, and E₃=j·\sqrt{κ}·Eᵢ.

Electric field at Port 0 is partially coupled into the ring through first coupler 915 and also outputs from Port 1. The optical signal in the ring is partially coupled into Port 2 through Coupler 2 and outputs from Port 2. When the input light wavelength, λ, satisfies the resonant condition, n_{eff} L=mλ, (n_{eff}=effective index of bending waveguide, L=length of the ring, and m is an integer) the coupling of the wavelength λ into the ring is enhanced leading to routing of light to Port 2. Polarization dependence should be balanced. Since the polarization dependence cannot be completely suppressed in each port, it can be balanced to effectively cancel the undesired electric field at the output port. For example, the TE mode can be designed to have a higher coupling ratio in the coupler, but more loss in the curved waveguide. Material defects and fabrication process lead to inter-port isolation.

FIG. 10 is an embodiment of a magneto-optic ring oscillator to provide a 1×4 magneto-optic optical switch 1000. Switch 1000 includes N number of waveguides (1005ᵢ, i=1 to N) having at least N−1 number of micro-ring magneto-optic waveguides 1010ⱼ, j=1 to N−1), each ring waveguide 1010ⱼ closely coupled between at least a pair of waveguides 1005ᵢ.

Bi-YIG materials have recently been used to realize integrated optical isolators for optical telecommunication systems. These devices make use of the Faraday effect in conjunction with a polarizer and an analyzer. Panorama Labs adopts novel nano-engineered remnant MO materials for low-power micro-displays, which can provide high-speed light attenuation switching through pulsed currents. The transmission spectra of a remnant MO micro-ring resonator driven by current pulses of different polarities have different resonant wavelengths. For a large peak current pulse, the change in output power at the resonant wavelength is sufficiently high to achieve fast optical shutter operation, which is the basis for fast optical routing. MO-based routers have the advantage of operating without the need of input polarization control (in comparison to electro-optic routers).

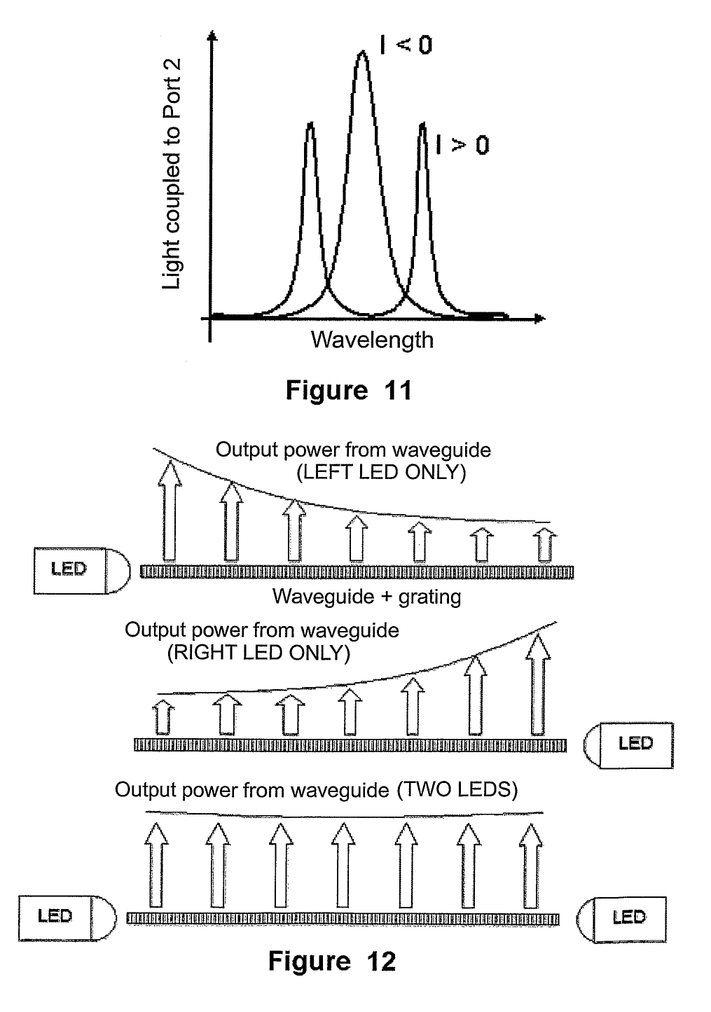

The MO ring resonator structure shown in FIG. 10 includes two waveguides 1005₁ and 1005₂ of ˜3 um×3 um size, and a MO ring 1010ₗ of ˜10 um diameter. A current pulse propagating upwards creates a magnetic field, B+ (shown as a “dot” in the center of a ring 1010ⱼ), in the anti-clockwise direction, while a current pulse propagating downwards creates a magnetic field, B− (shown as a “cross” in the center of a ring 1010ⱼ), in the clockwise direction. In general, a portion of any input light is coupled to port 2 through the ring resonator 1010ₗ. To achieve ideal optical switching from port 0 to port 2, the power coupled to port 1 must be zero. In practice, 30 dB isolation between port 1 and port 2 (that is P2/P1=1000) is adequate for most applications. By switching the direction of the current pulse the magnetization direction within the ring resonator changes, thus causing spectrum split as shown in FIG. 11 (similar to the optical shutter principle).

The ring structure may be optimized to maximize the isolation between ports and minimize the required current. Numerical modeling enables arbitrary ring shapes to be investigated for optimum switching performance (low insertion loss, and high inter-port isolation)—for example, non-circular ring 1010ⱼ pathways.

FIG. 11 is a graph illustrating spectral split of a propagating signal in the router shown in FIG. 10. A shown, for I<0, light coupled to port 2 is a maximum for a particular wavelength. For I>0, there is minimal coupling to port 2 at the particular wavelength. For a narrow input frequency centered at the particular frequency, the switching of the current results in the fast optical shutter.

FIG. 12 is a preferred embodiment for a magnitude distribution system 1200. System 1200 describes a system that may be used for a row or matrix array. By providing for multiple coupling waveguides 1010 along a length of a single waveguide, and providing for a non-planar exit port, each coupler may be a pixel or sub-pixel. As shown in the top two configurations, providing input signal/power at one end of a waveguide results in amplitude modulation the further along waveguide 1005 the output signal is extracted. By providing two sources of the input signal/power (shown as the bottom of the configurations in FIG. 12), one at each end of waveguide 1005ᵢ, the output power is significantly smoothed and evenly distributed along the length of the waveguide. This provides a better solution for certain implementations, such as for example, multiple coupling waveguides 1010ⱼ distributed along a length for uniform output power from each coupler, such as would be desirable for a display system, for example.

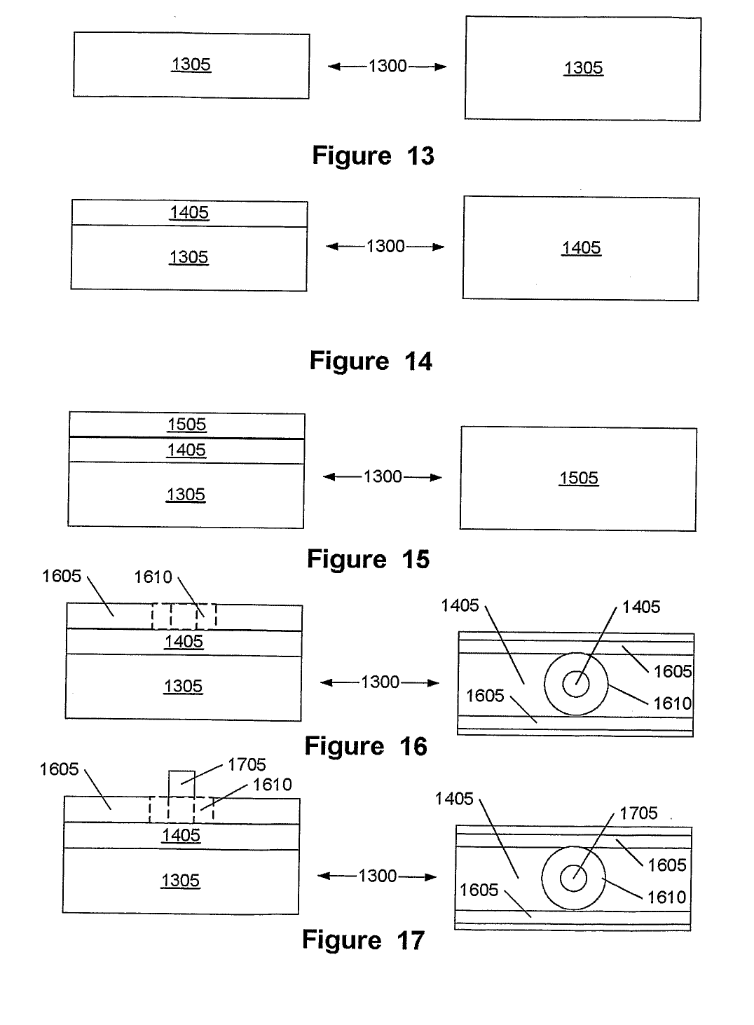

FIG. 13 through FIG. 17 are a series of block diagrams resulting from completion of a series of processing events for an MO micro-ring oscillator 1300 to be constructed on a substrate 1305. FIG. 13 is a side plan view (left hand side) and top plan view (right hand side) of substrate 1305. Substrate 1305 may be any suitable substrate for supporting the structures to be produced later (particularly the magneto-optic structures and waveguide structures)—silicon, gadolinium gallium garnet, zinc oxide, combinations thereof, or the like. FIG. 14 is a side plan view and top plan view of a metal 1405 (ground) production, for example deposition or other layer growing model. FIG. 15 is a side plan view and top plan view of a magneto-optic film 1505 production, such as by deposition or other layer growing model.

FIG. 16 is a side plan view and top plan view of a selective magneto-optic film 1505 removal. The selective removal may be performed by masking/etching or the like, suitable for the materials and desired final attributes. The selective removal produces waveguides 1605 (corresponding for example to the waveguides 1005ᵢ of FIG. 10) and ring waveguide 1610 (corresponding for example to ring waveguide 1010ⱼ of FIG. 10). FIG. 17 is a side plan view and top plan view of a selective second metal 1705 (core) production, such as by deposition or the like. Second metal 1705 provides a contact for receipt of plus and minus current (as appropriate) to produce the B+ and B− fields in waveguides 1610.

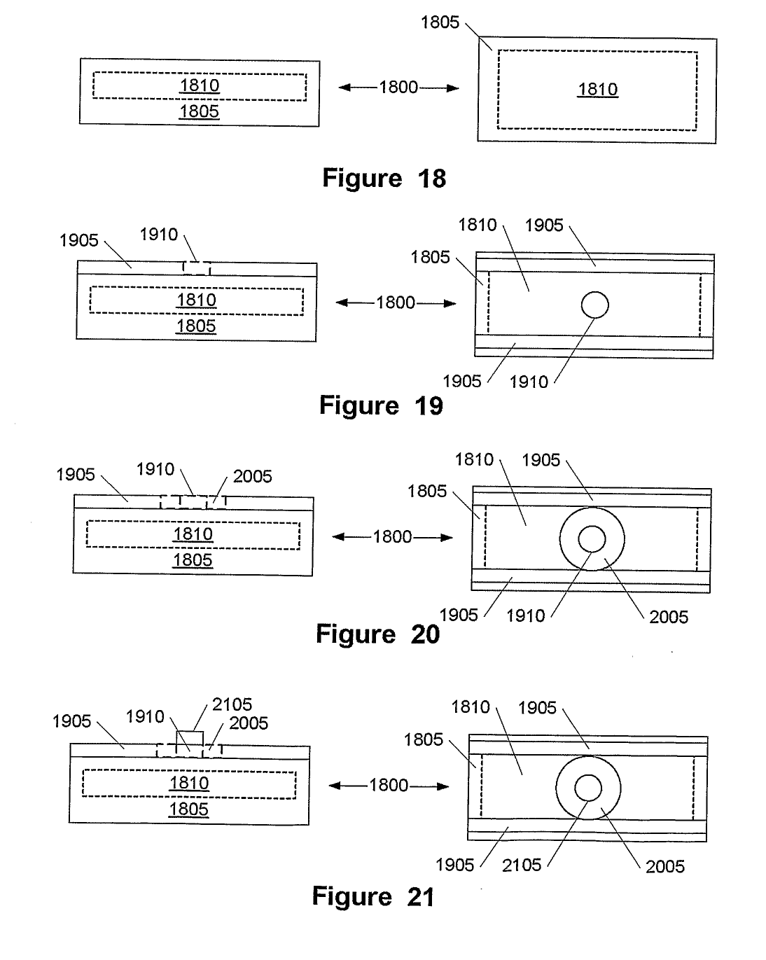

FIG. 18 through FIG. 21 are a series of block diagrams resulting from completion of a series of processing events for an MO micro-ring oscillator 1800 to be constructed on a substrate 1805 including VLSI circuitry 1810. FIG. 18 is a side plan view and top plan view of substrate 1805 including VLSI circuitry 1810. FIG. 19 is a side plan view and top plan view of a metal (ground) and waveguide production, producing waveguides 1905 and a contact region 1910. FIG. 20 is a side plan view and top plan view of a magneto-optic micro-ring 2005 production, such as by deposition (with etching as necessary). FIG. 21 is a side plan view and top plan view of a selective second metal 2105 (core) production, such as deposition\etch of the contact 2105.

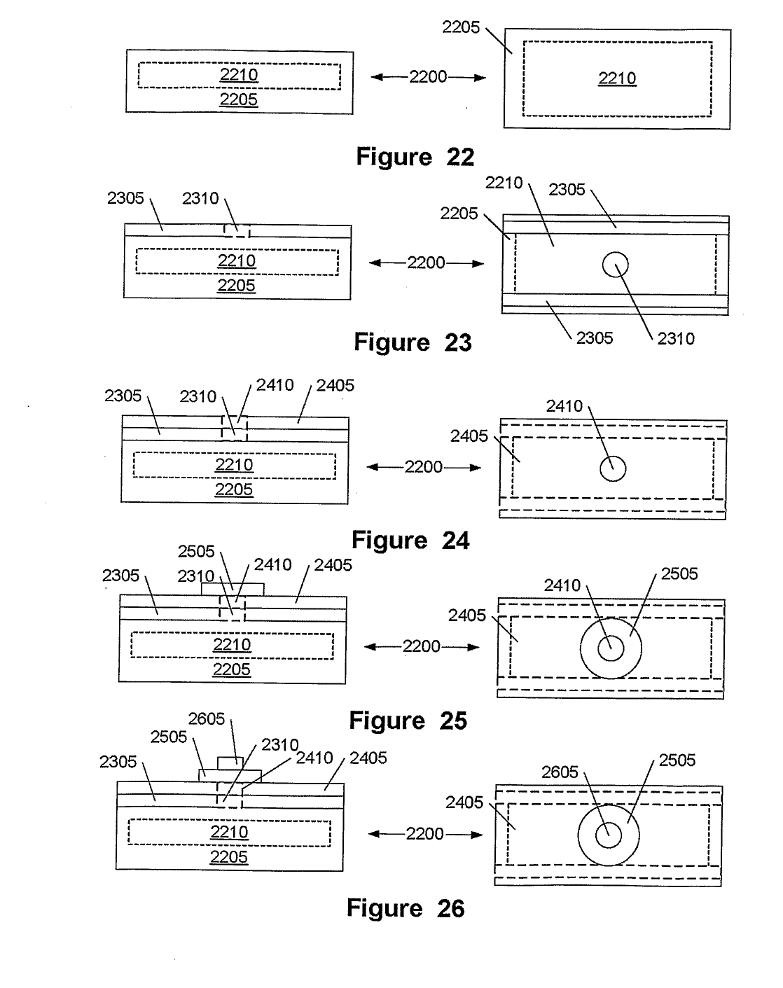

FIG. 22 through FIG. 26 are a series of block diagrams resulting from completion of a series of processing events for an MO micro-ring oscillator 2200 to be constructed on a substrate 2205 including VLSI circuitry 2210. FIG. 22 is a side plan view and top plan view of substrate 2205 including VLSI circuitry 2210. FIG. 23 is a side plan view and top plan view of a metal (ground) and waveguide production, producing waveguides 2305 and a contact region 2310. Waveguides 2305 include Si3N4. FIG. 24 is a side plan view and a top plan view of layer 2405 of SiO2 burying waveguides 2305 while providing a via 2410 for contacting contact region 2310. FIG. 25 is a side plan view and top plan view of a magneto-optic micro-ring 2505 production on top of layer 2405, such as by deposition (with etching as necessary). FIG. 26 is a side plan view and top plan view of a selective second metal 2605 (core) production, such as deposition\etch of the contact 2605.

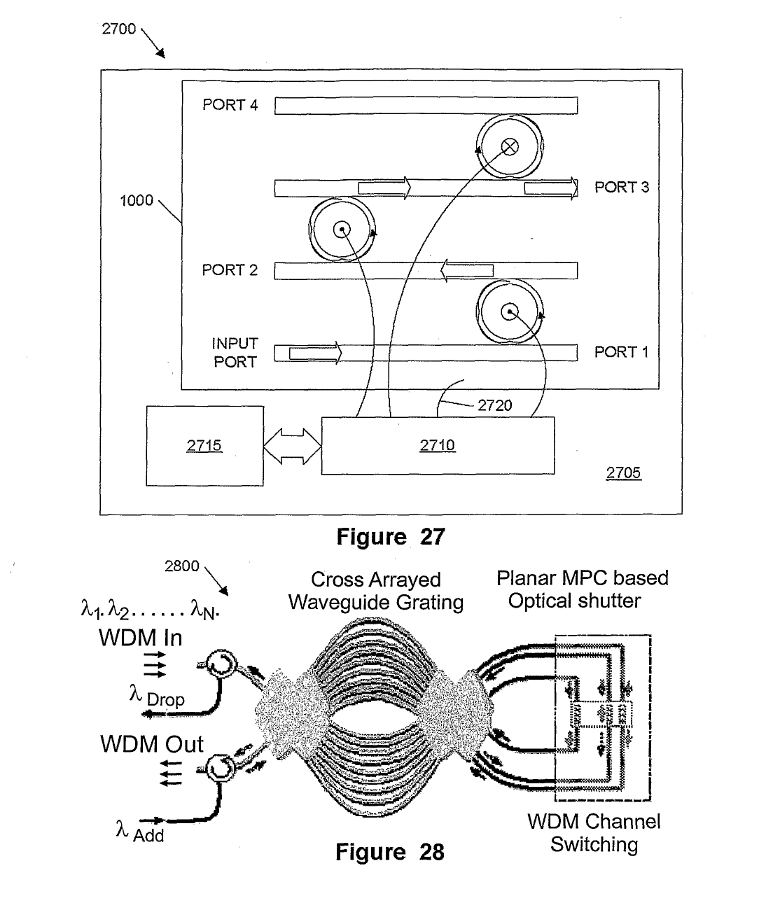

FIG. 27 is a representative embodiment of an integrated magneto-optic micro-ring 1×4 optical router 2700 disposed on a printed circuit board 2705. Router 2700 includes 1×4 switch 1000 shown in FIG. 10 mounted onto PCB 2705. PCB 2705 also includes a driver circuit 2710 for providing the +/− current (+/−I) required to independently generate the B+ and B− electric fields of the ring couplers of switch 1000. Driver 2710 is responsive to a controller 2715 to produce the appropriate drive currents, one connection 2720 from driver 2710 is a ground connection to the substrate of an integrated circuit supporting the waveguides and MO micro-ring oscillators/couplers of switch 1000. In operation, controller 2715 sets appropriate drive currents from driver 2710 to produce +/− currents for the ring oscillators of switch 1000 to selectively route an input radiation signal of a particular frequency at the input port to the desired output port (port 1-port 4).

FIG. 28 is a schematic diagram of a ROADM 2800 implemented using a planar magneto-photonic crystal (MPC)-based optical shutter as shown and described herein.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

We claim:

1. An apparatus, comprising:
a first waveguide supporting a propagation of a radiation signal from a first port to a second port;
a second waveguide including a second port; and
a ring-oscillator having a closed propagation pathway including magneto-optic materials, said ring-oscillator operationally coupled to said waveguides and responsive to a controlling influence to switch between a first mode and a second mode, with said first mode substantially non-interfering with said propagation of said radiation signal in said first waveguide and with said second mode routing said propagation of said radiation signal from said first port to said second port.

2. The apparatus of claim 1 wherein said second mode propagates substantially all of said radiation signal from said first port to said second port.

3. The apparatus of claim 2 wherein a ratio of a magnitude of an output signal of said second port in said second mode to a magnitude of an output signal of said first port in said first mode is at least about 30 dB.

4. An apparatus, comprising:
a driving waveguide supporting a propagation of a radiation signal from a first port to a second port; and
a plurality of output waveguides, each including an output port, each said output port disposed to output propagating radiation in a direction non-parallel to a direction of radiation exiting from said second port;
said plurality of ring-oscillators, each having a closed propagation pathway including magneto-optic materials, with each said ring-oscillator operationally coupled to said driving waveguide and one of said plurality of output waveguides and responsive to a controlling influence to independently switch between a first mode and a second mode, with said first mode substantially non-interfering with said propagation of said radiation signal in said first waveguide and with said second mode routing said propagation of said radiation signal from said first port to said output port.

5. The apparatus of claim 4 wherein said driving waveguide is disposed within a first plane and wherein said output ports are disposed in a second plane generally perpendicular to said first plane.

6. The apparatus of claim 4 wherein said driving waveguide further supports a second propagation of a second radiation signal from said second port to said first port.

7. The apparatus of claim 6 wherein said driving waveguide is disposed within a first plane and wherein said output ports are disposed in a second plane generally perpendicular to said first plane.

8. A method, the method comprising:
a) propagating a radiation signal in a first waveguide from a first port to a second port; and
b) selectably routing at least a portion of said radiation signal from said first port to a third port of a second waveguide using a magneto-optic ring oscillator coupled to said waveguides.

9. An MO optical switch comprising
a substrate;
an integrated circuit (VLSI) comprising electronic components carried on said substrate;
a plurality of first metal layers attached to and independently driven by the VLSI circuit;
a plurality of waveguides, preferably made of silicon nitride material, buried between the substrate and a SiO2 layer;
a plurality of ring resonators made of an MO material placed on top of the SiO2 layer;
wherein a diameter of a ring resonator is slightly smaller than, equal to, or slightly larger than a distance between the said waveguides, so that maximum coupling between said ring and waveguides is achieved.
wherein the ring shape is generally circular or an optimized shape to realize maximum coupling between said ring and waveguides;
a plurality of second metal layers connected to the plurality of first metal layers for providing a plurality electric currents along the axes of the MO ring resonators, and hence magnetic fields along the perimeters of the said ring resonators.
a memory carried on said VLSI circuit or an external electronic circuit for storing data representative of a switching state for said optical switch; and
a controller carried on said VLSI circuit or an external electronic circuit for utilizing said data and setting the currents driving the said ring resonator elements, so that any light coupled to an input port of a ring resonator element is independently switched to an output port of that particular ring resonator.

10. The optical switch of claim 9, wherein said VLSI circuit sets said current states for said ring resonator elements to direct a light from a first port to a second port.

11. The optical switch of claim 9, wherein said ring resonator elements have remanence so that the switching between input and output ports is realized by short, rather than long, current pulses.

12. The optical switch of claim 9, wherein said VLSI circuit balances the magnetic fields along the perimeters of said plurality of ring resonators to minimize a level of stray light directed to said plurality of ports other than the intended port, thus to yield an interport isolation value of more than 30 dB for all switching states.

13. The optical switch of claim 9, wherein said VLSI circuit computes said currents for said plurality of ring resonator elements to direct most of the input light to another of said plurality of ports.

14. The optical switch of claim 9, wherein said plurality of ring resonator elements is configured in an array.

15. The optical switch of claim 9, wherein said plurality of ring resonator elements directs said light to the first output port of a ring resonator through maximum transmission of said light.

16. The optical switch of claim 9, wherein said plurality of ring resonator elements couples said light to the second output port through resonance of said light within the ring resonator.

17. The optical switch of claim 9,
wherein said circuit receives a signal that represents whether said light is being switched to said second port, and
wherein said circuit computes said current state for said plurality of ring resonator elements to switch said light to said second port, in response to said signal.

18. The optical switch of claim 9, wherein said circuit determines a position of said second port by successively recomputing said current state for said plurality of ring resonator elements to successively redirect said light, and by successively evaluating said signal to determine whether said light is successfully switched to said second port.

19. The optical switch of claim 9,
wherein said VLSI circuit receives a signal that represents a current error of said light at said second port, and
wherein said circuit computes said current state for said plurality of ring resonator elements to correct for said current error, in response to said signal.

20. The optical switch of claim 9, wherein said VLSI circuit issues an output signal indicating a port contention, if said output port is in use when said circuit receives said input signal.

21. The optical switch of claim 9, wherein said VLSI circuit computes said current state for said plurality of ring resonator elements to switch said light from said first port to a third port, if said second port is in use when said circuit receives said input signal.

22. The optical switch of claim 9, wherein said VLSI circuit issues an output signal indicating that said light is being directed to said third port, if said second port is in use when said VLSI circuit receives said input signal.

23. The optical switch of claim 9, further comprising a plurality of matching waveguides or optical components to efficiently couple light signals of the said output ports into another array of waveguides, such as an optical fiber array, for further signal transmission or processing.
